(19) United States
(12) Patent Application Publication
(10) Pub. No.: US 2023/0247711 A1
(43) Pub. Date: Aug. 3, 2023

(54) METHOD AND DEVICE IN COMMUNICATION NODE FOR WIRELESS COMMUNICATION

(71) Applicants: Qiaoling YU, SHANGHAI (CN); Xiaobo ZHANG, SHANGHAI (CN)

(72) Inventors: Qiaoling YU, SHANGHAI (CN); Xiaobo ZHANG, SHANGHAI (CN)

(73) Assignee: SHANGHAI LANGBO COMMUNICATION TECHNOLOGY COMPANY LIMITED, SHANGHAI (CN)

(21) Appl. No.: 18/102,776

(22) Filed: Jan. 30, 2023

(30) Foreign Application Priority Data
Jan. 30, 2022 (CN) 202210114350.5

(51) Int. Cl. H04W 76/27

(52) U.S. Cl. CPC H04W 76/27

(57) ABSTRACT

The present application discloses a method and a device in a communication node for wireless communications. A communication node receives a first message, the first message indicating at least a first bearer; and as a response to receiving the first message, enters or stays in an RRC Inactive state; and receives a first signaling and a second message while transmitting data via the first bearer in the RRC Inactive state, the first signaling comprising scheduling information of a first channel, and at least the second message being transmitted on the first channel, the second message being used to trigger data transmission via a second bearer; one of the first bearer and the second bearer is an MRB while the other is a DRB; the first signaling is scrambled by a first RNTI; if the first bearer is an MRB, the first RNTI belongs to a first candidate RNTI set.

### CROSS REFERENCE TO RELATED APPLICATIONS

This application claims the priority benefit of Chinese Patent Application No. 202210114350.5, filed on Jan. 30, 2022, the full disclosure of which is incorporated herein by reference.

### BACKGROUND

### Technical Field

The present application relates to transmission methods and devices in wireless communication systems, and in particular to a method and a device for transmission in inactive state.

### Related Art

The New Radio (NR) supports Radio Resource Control INACTIVE (RRC_INACTIVE) State till the 3rd Generation Partnership Project (3GPP) Rel-16 in which transmitting or receiving data is no longer supported in a RRC_INACTIVE State. The Rel-17 starts a Work Item (WI) of “NR INACTIVE state Small Data Transmission (SDT)” to study the technique of small data packet transmission in a RRC_INACTIVE state, including transmitting uplink data on pre-configured Physical Uplink Shared Channel (PUSCH) resources, or carrying data by means of either a Message 3 (Msg3) or a Message B (MsgB) in a Random Access (RA) procedure; the Rel-17 starts a Work Item (WI) of “receiving Multicast/Broadcast Service (MB S) in an RRC connected state”; the Rel-18 conducts studies on MBS reception in the RRC_INACTIVE state, and also on downlink data transmission in the RRC_INACTIVE state.

### SUMMARY

When there are MBS services for a base station, the base station transmits a paging message, when a UE receives the paging message, if the paging message comprises a Temporary Mobile Group Identity (TMGI) and the UE is joined in this TMGI, the UE will initiate an RRC Resume procedure and enters an RRC connected state to receive MBS. However, the existing protocol does not support the UE in receiving a paging message while performing SDT procedure in an RRC_INACTIVE state, which leads to a result that the UE cannot receive MBS during a SDT. Similarly, the Rel-18 will make a study of receiving MBS in an RRC_INACTIVE state, while receiving MBS, if no paging message can be received, and when a downlink data transmission is ongoing in the base station, it cannot notify the UE via the paging message. Therefore, it is necessary to have some enhancement in how to ensure support to other service transmissions while performing SDT or receiving MBS in an RRC_INACTIVE state.

To address the above problem, the present application provides a solution. Although the description above only takes NR scenarios as an example; the present application is also applicable to scenarios such as Long Term Evolution (LTE) or Narrow Band Internet of Things (NB-IoT), where similar technical effects can be achieved. Additionally, the adoption of a unified solution for various scenarios contributes to the reduction of hardcore complexity and costs.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

The present application provides a method in a first node for wireless communications, comprising:

receiving a first message, the first message indicating at least a first bearer; and as a response to receiving the first message, entering or staying in an RRC Inactive state; and

receiving at least a former of a first signaling or a second message while transmitting data via the first bearer in the RRC Inactive state, the first signaling or the second message being used to trigger data transmission via a second bearer;

herein, one of the first bearer and the second bearer is a MBS Radio Bearer (MRB) while the other is a Data Radio Bearer (DRB (user)); the first signaling is scrambled by a first Radio Network Temporary Identifier (RNTI); the first RNTI is related to the first bearer; if the first bearer is an MRB, the first RNTI is an RNTI in a first candidate RNTI set, or if the first bearer is a DRB, the first RNTI is an RNTI in a second candidate RNTI set; the first candidate RNTI set comprises at least a G-RNTI; the second candidate RNTI set comprises at least a Cell RNTI (C-RNTI).

In one embodiment, the first signaling and the second message are both received.

In one subembodiment, the first channel is a Physical Downlink Shared Channel (PDSCH), and the second message is used to trigger data transmission via a second bearer.

In one subembodiment, the first channel is a PDSCH or a PUSCH, and the first signaling is used to trigger data transmission via a second bearer.

In one embodiment, only the first signaling is received, and the second message is not received, the first signaling being used to trigger data transmission via a second bearer.

In one embodiment, the first bearer is an MRB while the second bearer is a DRB; the first signaling is scrambled by a first RNTI; the first RNTI is related to the first bearer; the first RNTI is an RNTI in a first candidate RNTI set, the first candidate RNTI set comprises at least a Group RNTI (G-RNTI).

In one embodiment, the first bearer is a DRB while the second bearer is an MRB; the first signaling is scrambled by a first RNTI; the first RNTI is related to the first bearer; the first RNTI is an RNTI in a second candidate RNTI set, the second candidate RNTI set comprises at least a C-RNTI.

In one embodiment, the first signaling comprises scheduling information of a first channel, and at least the second message is transmitted on the first channel.

In one embodiment, a problem to be solved in the present application includes: how to notify the UE that data shall be transmitted via a second bearer during a period of transmitting data via the first bearer in the RRC Inactive state.

In one embodiment, a problem to be solved in the present application includes: how to reduce power consumption of the UE in an RRC Inactive state.

In one embodiment, a problem to be solved in the present application includes: how to realize the design of compatibility between SDT and MBS.

In one embodiment, characteristics of the above method include: notifying the UE via a signaling other than the paging message that data shall be transmitted via a second bearer during a period of transmitting data via the first bearer in the RRC Inactive state.

In one embodiment, characteristics of the above method include: using a channel related to MBS to notify the UE that data shall be transmitted via a DRB during a period of receiving MBS services in the RRC Inactive state.

In one embodiment, characteristics of the above method include: using a channel related to SDT to notify the UE that data shall be transmitted via an MRB during a period of performing SDT in the RRC Inactive state.

In one embodiment, characteristics of the above method include: using a message other than the paging message to provide the functionality of paging message.

In one embodiment, an advantage of the above method includes: avoiding the usage of paging messages, which helps reduce power consumption of other UEs in RRC Inactive state.

In one embodiment, an advantage of the above method includes: targeting at scenarios of not listening over paging messages during SDT, thus enabling the UE to trigger MBS reception during SDT.

In one embodiment, an advantage of the above method includes increasing the efficiency of paging.

According to one aspect of the present application, characterized in comprising:

transmitting a third message as a response to receiving the second message, the third message being used for an RRC connection resume procedure; and

monitoring a fourth message as a response to the third message being transmitted; and

resuming the second bearer along with the RRC connection resume procedure;

herein, the fourth message belongs to the RRC connection resume procedure.

According to one aspect of the present application, characterized in comprising:

resuming the second bearer as a response to receiving the second message; the action of receiving the second message does not trigger an RRC connection resume procedure.

According to one aspect of the present application, characterized in that the second message comprises a first identity of the first node, where the first identity of the first node is unique in at least one cell; the first bearer is an MRB, and the first RNTI is an RNTI in the first candidate RNTI set.

According to one aspect of the present application, characterized in that the second message comprises a second identity, the second identity being used to indicate a first MBS session, the first node being joined in the first MBS session; the first bearer is a DRB, and the first RNTI is an RNTI in the second candidate RNTI set.

According to one aspect of the present application, characterized in that the second message indicates that data is to be transmitted via the second bearer in the RRC Inactive state.

According to one aspect of the present application, characterized in that the second message indicates that data is to be transmitted via the second bearer in the RRC Connected state.

The present application provides a method in a second node for wireless communications, comprising:

transmitting a first message, the first message indicating at least a first bearer; and

transmitting a first signaling and a second message, the first signaling comprising scheduling information of a first channel, and at least the second message being transmitted on the first channel, the second message being used to trigger data transmission via a second bearer;

herein, as a response to the first message being received, a receiver receiving the first message enters or stays in an RRC Inactive state; the first signaling and the second message are received by the receiver receiving the first message while transmitting data via the first bearer in the RRC Inactive state; one of the first bearer and the second bearer is an MRB while the other is a DRB; the first signaling is scrambled by a first RNTI; the first RNTI is related to the first bearer; if the first bearer is an MRB, the first RNTI is an RNTI in a first candidate RNTI set, or if the first bearer is a DRB, the first RNTI is an RNTI in a second candidate RNTI set; the first candidate RNTI set comprises at least a G-RNTI, and the second candidate RNTI set comprises at least a C-RNTI.

According to one aspect of the present application, characterized in comprising:

receiving a third message, the third message being used for an RRC connection resume procedure; and

determining whether to transmit a fourth message, as a response to the third message being received;

herein, along with the RRC connection resume procedure, the second bearer is resumed; the fourth message belongs to the RRC connection resume procedure; and the second message is used to trigger the third message.

According to one aspect of the present application, characterized in that as a response to the second message being received by a receiver receiving the first message, the second bearer is resumed; the second message being received by the receiver receiving the first message does not trigger an RRC connection resume procedure.

According to one aspect of the present application, characterized in that the second message comprises a first identity of a receiver receiving the first message, where the first identity of the receiver receiving the first message is unique in at least one cell; the first bearer is an MRB, and the first RNTI is an RNTI in the first candidate RNTI set.

According to one aspect of the present application, characterized in that the second message comprises a second identity, the second identity being used to indicate a first MBS session, a receiver receiving the first message being joined in the first MBS session; the first bearer is a DRB, and the first RNTI is an RNTI in the second candidate RNTI set.

According to one aspect of the present application, characterized in that the second message indicates that data is to be transmitted via the second bearer in the RRC Inactive state.

According to one aspect of the present application, characterized in that the second message indicates that data is to be transmitted via the second bearer in the RRC Connected state.

The present application provides a first node for wireless communications, comprising:

a first receiver, which receives a first message, the first message indicating at least a first bearer; and as a response to receiving the first message, enters or stays in an RRC Inactive state; and receives a first signaling and a second message while transmitting data via the first bearer in the RRC Inactive state, the first signaling comprising scheduling information of a first channel, and at least the second message being transmitted on the first channel, the second message being used to trigger data transmission via a second bearer;

herein, one of the first bearer and the second bearer is an MRB while the other is a DRB; the first signaling is scrambled by a first RNTI; the first RNTI is related to the first bearer; if the first bearer is an MRB, the first RNTI is an RNTI in a first candidate RNTI set, or if the first bearer is a DRB, the first RNTI is an RNTI in a second candidate RNTI set; the first candidate RNTI set comprises at least a G-RNTI, and the second candidate RNTI set comprises at least a C-RNTI.

The present application provides a second node for wireless communications, comprising:

a second transmitter, which transmits a first message, the first message indicating at least a first bearer; and transmits a first signaling and a second message, the first signaling comprising scheduling information of a first channel, and at least the second message being transmitted on the first channel, the second message being used to trigger data transmission via a second bearer;

herein, as a response to the first message being received, a receiver receiving the first message enters or stays in an RRC Inactive state; the first signaling and the second message are received by the receiver receiving the first message while transmitting data via the first bearer in the RRC Inactive state; one of the first bearer and the second bearer is an MRB while the other is a DRB; the first signaling is scrambled by a first RNTI; the first RNTI is related to the first bearer; if the first bearer is an MRB, the first RNTI is an RNTI in a first candidate RNTI set, or if the first bearer is a DRB, the first RNTI is an RNTI in a second candidate RNTI set; the first candidate RNTI set comprises at least a G-RNTI, and the second candidate RNTI set comprises at least a C-RNTI.

In one embodiment, compared with the prior art, the present application is advantageous in the following aspects:
avoiding the usage of paging messages, which helps reduce power consumption of other UEs in RRC Inactive state;
targeting at scenarios of not listening over paging messages during SDT, thus enabling the UE to trigger MBS reception during SDT;
enhancing the efficiency of paging.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmission of a first message, a first signaling and a second message according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of radio signal transmission according to one embodiment of the present application.

FIG. 6 illustrates a flowchart of radio signal transmission according to another embodiment of the present application.

FIG. 7 illustrates a schematic diagram of a second message comprising a first identity of a first node according to one embodiment of the present application.

FIG. 8 illustrates a schematic diagram of a second message comprising a second identity according to one embodiment of the present application.

FIG. 9 illustrates a schematic diagram of a second message indicating data transmission via a second bearer in an RRC Inactive state according to one embodiment of the present application.

FIG. 10 illustrates a schematic diagram of a second message indicating data transmission via a second bearer in an RRC Connected state according to one embodiment of the present application.

FIG. 11 illustrates a structure block diagram of a processing device used in a first node according to one embodiment of the present application.

FIG. 12 illustrates a structure block diagram of a processing device used in a second node according to one embodiment of the present application.

FIG. 13 illustrates a flowchart of transmission of a first message and a first signaling according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

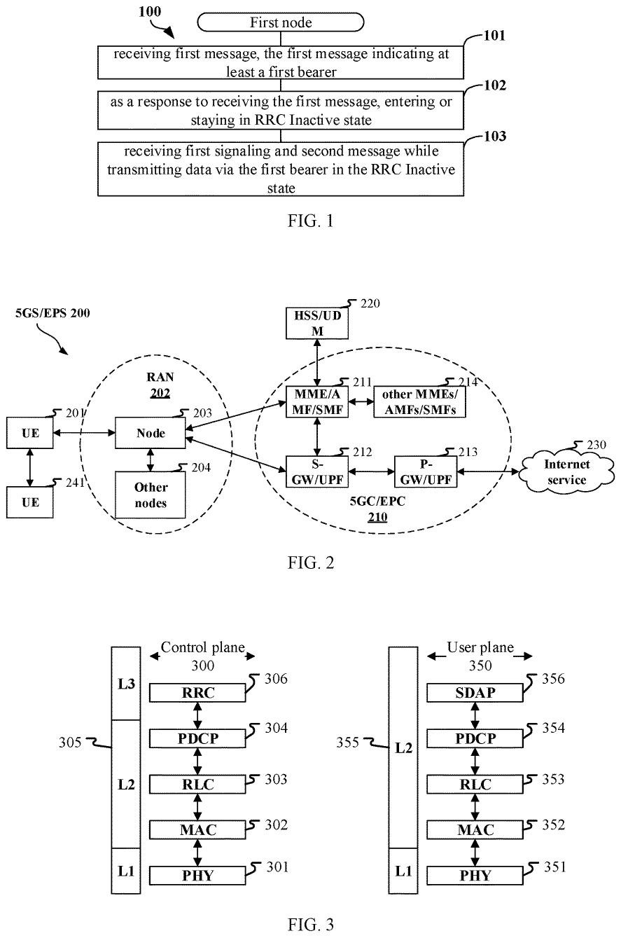

Embodiment 1 illustrates a flowchart of transmission of a first message, a first signaling and a second message according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application receives a first message in step 101, the first message indicating at least a first bearer; and as a response to receiving the first message, enters or stays in an RRC Inactive state in step 102; and receives a first signaling and a second message while transmitting data via the first bearer in the RRC Inactive state in step 103, the first signaling comprising scheduling information of a first channel, and at least the second message being transmitted on the first channel, the second message being used to trigger data transmission via a second bearer; herein, one of the first bearer and the second bearer is an MRB while the other is a DRB; the first signaling is scrambled by a first RNTI; the first RNTI is related to the first bearer; if the first bearer is an MRB, the first RNTI is an RNTI in a first candidate RNTI set, or if the first bearer is a DRB, the first RNTI is an RNTI in a second candidate RNTI set; the first candidate RNTI set comprises at least a G-RNTI, and the second candidate RNTI set comprises at least a C-RNTI.

In one embodiment, a receiver receiving the first message is the second node in the present application.

In one embodiment, a receiver receiving the first message and a receiver receiving the first signaling are the same.

In one embodiment, a receiver receiving the first message and a receiver receiving the first signaling are different.

In one embodiment, a receiver receiving the first signaling and a receiver receiving the second message are the same.

In one embodiment, the first message comprises an RRC message.

In one embodiment, a logical channel of the first message is a Dedicated Control CHannel (DCCH).

In one embodiment, a Signaling Radio Bearer (SRB) for the first message is an SRB1.

In one embodiment, the first message comprises an RRCRelease message.

In one embodiment, the first message comprises an RRCConnectionRelease message.

In one embodiment, the first message comprises at least one RRC Information Element (IE).

In one embodiment, the first message comprises at least one RRC field.

In one embodiment, the first message comprises an RRC field, and names of the RRC field include suspendConfig.

In one embodiment, at least one RRC IE or at least one RRC field in the first message indicates the first DRB.

In one embodiment, the first message comprises a suspendConfig field in an RRCRelease message.

In one embodiment, the first message is a suspendConfig field in an RRCRelease message.

In one embodiment, the first message comprises a field in an RRCConnectionRelease message of which names include RRC-InactiveConfig.

In one embodiment, the first message is a field in an RRCConnectionRelease message of which names include RRC-InactiveConfig.

In one embodiment, the first message is a field in an RRCConnectionRelease message of which names include RRCConnectionRelease.

In one embodiment, the first message explicitly indicates the first bearer.

In one embodiment, the first message implicitly indicates the first bearer.

In one embodiment, the phrase that the first message indicates at least a first bearer comprises: the first message indicates the first bearer, and, the first bearer indicates the second bearer.

In one subembodiment, the first message explicitly indicates the second bearer.

In one subembodiment, the first message implicitly indicates the second bearer.

In one embodiment, the phrase that the first message indicates at least a first bearer comprises: the first message indicates the first bearer, and, the first bearer does not indicate the second bearer.

In one embodiment, the first message indicating the first bearer comprises: the first message comprises configuration information of the first bearer.

In one embodiment, the first message indicating the first bearer comprises: the first message comprises an identifier of the first bearer.

In one embodiment, the first bearer indicating the second bearer comprises: the first message comprises configuration information of the second bearer.

In one embodiment, the first bearer indicating the second bearer comprises: the first message comprises an identifier of the second bearer.

In one embodiment, the first message comprises a drb-ContinueROHC used to indicate the first bearer.

In one embodiment, the first message comprises a field of which the name includes drb-ContinueROHC being used to indicate the first bearer.

In one embodiment, the first message comprises an mrb-ContinueROHC used to indicate the first bearer.

In one embodiment, the first message comprises a field of which the name includes mrb-ContinueROHC being used to indicate the first bearer.

In one embodiment, the first message indicates that the first bearer can be used for performing data transmission via the first bearer in the RRC Inactive state.

In one embodiment, the first message indicates that the second bearer can be used for performing data transmission via the second bearer in the RRC Inactive state.

In one embodiment, the first message indicates at least one first-type DRB, and the first message does not indicate any first-type MRB; the first bearer is any first-type DRB of the at least one first-type DRB.

In one embodiment, the first message indicates at least one first-type MRB, and the first message does not indicate any first-type DRB; the first bearer is any first-type MRB of the at least one first-type MRB.

In one embodiment, the first message indicates at least one first-type DRB, and the first message indicates at least one first-type MRB; the first bearer is any first-type DRB of the at least one first-type DRB, and the second bearer is any first-type MRB of the at least one first-type MRB.

In one embodiment, the first message indicates at least one first-type DRB, and the first message indicates at least one first-type MRB; the first bearer is any first-type MRB of the at least one first-type MRB, and the second bearer is any first-type DRB of the at least one first-type DRB.

In one embodiment, within a time interval between a time of the first message being received and a time of the first signaling being received, the second bearer is not released.

In one embodiment, within a time interval between a time of the first message being received and a time of the first signaling being received, the second bearer is in suspended state.

In one embodiment, before the first signaling is received, the second bearer is not released.

In one embodiment, before the first signaling is received, the second bearer is in suspended state.

In one embodiment, as a response to receiving the first message, all the first-type bearers are suspended.

In one embodiment, as a response to receiving the first message, all the second-type bearers are suspended.

In one embodiment, as a response to receiving the first message, the first bearer is suspended.

In one embodiment, as a response to receiving the first message, the second bearer is suspended.

In one embodiment, as a response to receiving the first message, the first bearer and the second bearer are suspended.

In one embodiment, as a response to receiving the first message, the first bearer is maintained and the second bearer is suspended.

In one embodiment, the phrase that the first bearer is maintained means that if the first bearer is in suspended state, after receiving the first message the first bearer is still suspended.

In one embodiment, the phrase that the first bearer is maintained means that if the first bearer is not in suspended state, after receiving the first message the first bearer is not suspended.

In one embodiment, as a response to receiving the first message, enter an RRC Inactive state.

In one embodiment, as a response to receiving the first message, stay in an RRC Inactive state.

In one embodiment, as a response to the first message being received, the first node U01 is in an RRC Inactive state.

In one embodiment, the first message is used to enable the first node U01 to enter an RRC Inactive state from an RRC Connected state.

In one embodiment, the first message is used to enable the first node U01 to stay in an RRC Inactive state.

In one embodiment, before the first message is received, the first node U01 is in an RRC Connected state.

In one embodiment, before the first message is received, the first node U01 is in an RRC Inactive state.

In one embodiment, after the first message is received, the first node U01 is in an RRC Inactive state.

In one embodiment, during a period of transmitting data via the first bearer in the RRC Inactive state, the first bearer is configured, and the first bearer is not suspended.

In one embodiment, during a period of transmitting data via the first bearer in the RRC Inactive state, at least one uplink data is transmitted, or, at least one downlink data is received.

In one embodiment, during a period of transmitting data via the first bearer in the RRC Inactive state, an SRB1 is not suspended.

In one embodiment, during a period of transmitting data via the first bearer in the RRC Inactive state, an SRB1 is suspended.

In one embodiment, during a period of transmitting data via the first bearer in the RRC Inactive state, an SRB2 is not suspended.

In one embodiment, during a period of transmitting data via the first bearer in the RRC Inactive state, an SRB2 is suspended.

In one embodiment, during a period of transmitting data via the first bearer in the RRC Inactive state, the second bearer is suspended.

In one embodiment, during a period of transmitting data via the first bearer in the RRC Inactive state, the first timer is running.

In one embodiment, transmitting data via the first bearer in the RRC Inactive state means: performing Early Data Transmission (EDT) in the RRC Inactive state; the first bearer is a first-type DRB.

In one embodiment, transmitting data via the first bearer in the RRC Inactive state means: performing SDT in the RRC Inactive state; the first bearer is a first-type DRB.

In one embodiment, transmitting data via the first bearer in the RRC Inactive state means: performing MT-SDT in the RRC Inactive state; the first bearer is a first-type DRB.

In one embodiment, transmitting data via the first bearer in the RRC Inactive state means: performing MO-SDT in the RRC Inactive state; the first bearer is a first-type DRB.

In one embodiment, transmitting data via the first bearer in the RRC Inactive state means: receiving MBS in the RRC Inactive state; the first bearer is a first-type MRB.

In one embodiment, the first bearer being resumed in the RRC Inactive state is used to determine that data is transmitted via the first bearer in the RRC Inactive state.

In one embodiment, a first timer being running is used to determine that data is transmitted via the first bearer in the RRC Inactive state, the first timer not being T319.

In one embodiment, transmitting data via the first bearer in the RRC Inactive state belongs to a first RRC update procedure.

In one embodiment, the first RRC update procedure comprises: transmitting a first target message, the first target message being transmitted through a Common Control Channel (CCCH).

In one subembodiment, the first target message comprises an RRCResumeRequest message or an RRCResumeRequest1 message.

In one subembodiment, the first target message comprises an RRCConnectionResumeRequest message or an RRCEarlyDataRequest message.

In one embodiment, the first RRC update procedure comprises: receiving a second target message.

In one subembodiment, the second target message comprises one of an RRCRelease message, or an RRCResume message, or an RRCReject message, or an RRCSetup message.

In one subembodiment, the second target message comprises one of an RRCConnectionResume message, or an RRCEarlyDataComplete message, or an RRCConnectionReject message, or an RRCConnectionSetup message, or an RRCConnectionRelease message.

In one embodiment, the first RRC update procedure comprises: starting the first timer along with the first target message.

In one embodiment, the first RRC update procedure comprises: stopping the first timer if the second target message is received.

In one embodiment, the first RRC update procedure comprises: resuming the first bearer along with the first target message.

In one embodiment, the first RRC update procedure comprises: resuming the first bearer along with the second target message.

In one embodiment, the first timer being expired is used to determine to enter an RRC_IDLE state.

In one embodiment, the first timer being expired is used to determine to enter an RRC Inactive state.

In one embodiment, the first timer being expired is used to determine to suspend the first bearer.

In one embodiment, the first timer is running when the first signaling and the second message are received.

In one embodiment, the first target message is transmitted and the second target message is not received when the first signaling and the second message are received.

In one embodiment, the second timer is not expired and the second target message is not received when the first signaling and the second message are received.

In one embodiment, transmitting data via the first bearer in the RRC Inactive state does not belong to a first RRC update procedure.

In one embodiment, as a response to receiving a first paging message, the first bearer is resumed.

In one embodiment, during a time interval between receiving the first paging message and resuming the first bearer, the first node does not transmit an RRC message transmitted through a CCCH.

In one embodiment, the first paging message comprises an identity of the first node.

In one embodiment, the first paging message comprises a first identity of the first node.

In one embodiment, the first paging message comprises a TMGI, the first node being joined in one or more MBS sessions identified by the TMGI.

In one embodiment, the first paging message comprises a second identity.

In one embodiment, receiving the first paging message is used to trigger the first RRC update procedure, the first RRC update procedure being used to determine that data is transmitted via the first bearer in the RRC Inactive state.

In one embodiment, each condition in a first condition set being satisfied is used to trigger the first RRC update procedure, the first RRC update procedure being used to determine that data is transmitted via the first bearer in the RRC Inactive state.

In one embodiment, receiving the first paging message is used to determine that data is transmitted via the first bearer in the RRC Inactive state.

In one embodiment, the first paging message is received.

In one embodiment, the first paging message is not received.

In one embodiment, the first RRC update procedure is performed.

In one embodiment, the first RRC update procedure is not performed.

In one embodiment, as a response to receiving the first message, the first bearer is suspended; before transmitting data via the first bearer in the RRC Inactive state, the first bearer is resumed in the first place.

In one embodiment, as a response to receiving the first message, the first bearer is not suspended.

In one embodiment, the first channel comprises a PDSCH.

In one embodiment, the first channel is a PDSCH.

In one embodiment, the first signaling is used for scheduling a PDSCH.

In one embodiment, the first signaling is used to indicate physical-layer scheduling information of the first channel.

In one embodiment, the first signaling is not a DCI format 1_0 of which Cyclic Redundancy Check (CRC) is scrambled by a Paging RNTI (P-RNTI).

In one embodiment, the scheduling information of the first channel comprises at least one of Frequency domain resource assignment, or Time domain resource assignment, or Virtual resource block-to-Physical resource block mapping (VRB-to-PRB mapping), or Modulation and coding scheme (MCS), or a New data indicator (NDI), or a Redundancy version (RV), or a Hybrid automatic repeat request (HARQ) process number.

In one embodiment, the second message is not a paging message.

In one embodiment, a logical channel of the second message is not a PCCH.

In one embodiment, the first signaling does not comprise a field being used to indicate short messages.

In one embodiment, the first signaling comprises a DCI.

In one embodiment, the first signaling is a DCI.

In one embodiment, the first signaling comprises a DCI Format 4_0; the first bearer is an MRB.

In one embodiment, the first signaling comprises a DCI Format 4_1; the first bearer is an MRB.

In one embodiment, the first signaling comprises a DCI Format 4_2; the first bearer is an MRB.

In one embodiment, the first signaling comprises a DCI format 1_0; the first bearer is a DRB.

In one embodiment, the first signaling comprises a DCI format 1_1; the first bearer is a DRB.

In one embodiment, the first signaling comprises a DCI format 1_2; the first bearer is a DRB.

In one embodiment, the first signaling is a DCI scrambled by the first RNTI.

In one embodiment, the first signaling is a DCI with CRC being scrambled by the first RNTI.

In one embodiment, the first signaling is scrambled by the first RNTI.

In one embodiment, the second message is an AS message.

In one embodiment, the second message is a higher-layer message.

In one embodiment, the second message is an RRC message.

In one embodiment, the second message is an RRC message.

In one embodiment, the second message comprises at least one RRC IE.

In one embodiment, the second message comprises at least one RRC field.

In one embodiment, the second message is a MAC Control Element (CE).

In one embodiment, the second message is a MAC subheader.

In one embodiment, the second message is a MAC field in a MAC CE.

In one embodiment, the second message is a MAC field in a MAC subheader.

In one embodiment, the first bearer is a DRB.

In one subembodiment, the second message is transmitted via an SRB0.

In one subembodiment, the second message is transmitted via an SRB1.

In one subembodiment, the second message is transmitted via an SRB2.

In one subembodiment, the second message is transmitted via a new SRB.

In one subembodiment, the second message is transmitted via a DRB.

In one subembodiment, a logical channel of the second message is a CCCH.

In one subembodiment, a logical channel of the second message is a DCCH.

In one subembodiment, a logical channel of the second message is a Dedicated Traffic Channel (DTCH).

In one subembodiment, a receiver receiving the second message only includes the first node.

In one embodiment, the first bearer is an MRB.

In one subembodiment, the second message is transmitted via an MRB.

In one subembodiment, the second message is transmitted via a multicast MRB.

In one subembodiment, the second message is transmitted via a broadcast MRB.

In one subembodiment, a logical channel of the second message is a MBS Control Channel (MCCH).

In one subembodiment, a logical channel of the second message is a MBS Traffic Channel (MTCH).

In one subembodiment, a receiver receiving the second message includes at least the first node.

In one subembodiment, a receiver receiving the second message includes the first node and other node.

In one embodiment, if the second bearer is a first-type DRB, the phrase of transmitting data via the second bearer means: performing SDT in the RRC Inactive state.

In one embodiment, if the second bearer is a first-type DRB, the phrase of transmitting data via the second bearer means: performing MT-SDT in the RRC Inactive state.

In one embodiment, if the second bearer is a first-type DRB, the phrase of transmitting data via the second bearer means: performing MO-SDT in the RRC Inactive state.

In one embodiment, if the second bearer is a first-type DRB, the phrase of transmitting data via the second bearer means: receiving downlink data in an RRC Connected state.

In one embodiment, if the second bearer is a first-type MRB, the phrase of transmitting data via the second bearer means: receiving MBS in the RRC Inactive state.

In one embodiment, the phrase that the second message is used to trigger data transmission via a second bearer can be replaced with the following: the second message is used to trigger data transmission via the second bearer in an RRC Connected state.

In one embodiment, the phrase that the second message is used to trigger data transmission via a second bearer can be replaced with the following: the second message is used to trigger data transmission via the second bearer in an RRC Connected state.

In one embodiment, the phrase that the second message is used to trigger data transmission via a second bearer can be replaced with the following: the second message is used to trigger an RRC connection resume procedure, the RRC connection resume procedure being used for transmitting data via the second bearer in the RRC Inactive state.

In one embodiment, the phrase that the second message is used to trigger data transmission via a second bearer can be replaced with the following: the second message is used to trigger an RRC connection resume procedure, the RRC connection resume procedure being used for transmitting data via the second bearer in the RRC Connected state.

In one embodiment, the phrase that the second message is used to trigger data transmission via a second bearer can be replaced with the following: the second message is used to trigger an RRC connection resume procedure, the RRC connection resume procedure being used for switching from the RRC Inactive state to the RRC Connected state.

In one embodiment, as a response to receiving the second message, data is transmitted via the second bearer in the RRC Connected state.

In one embodiment, as a response to receiving the second message, data is transmitted via the second bearer in the RRC Inactive state.

In one embodiment, the MRB includes a multicast MRB.

In one embodiment, the MRB includes a broadcast MRB.

In one embodiment, the MRB only includes a multicast MRB rather than a broadcast MRB.

In one embodiment, the first bearer is configured in the RRC Connected state.

In one embodiment, the second bearer is configured in the RRC Connected state.

In one embodiment, the first bearer is configured in the RRC Inactive state.

In one embodiment, the second bearer is configured in the RRC Inactive state.

In one embodiment, the first bearer is an MRB, while the second bearer is a DRB.

In one embodiment, the first bearer is a DRB, while the second bearer is an MRB.

In one embodiment, the first bearer is a bearer identified by an MRB-Identity, while the second bearer is a bearer identified by a DRB-Identity.

In one embodiment, the first bearer is a bearer identified by a DRB-Identity, while the second bearer is a bearer identified by an MRB-Identity.

In one embodiment, the MRB-Identity is used for identifying a multicast MRB.

In one embodiment, the MRB-Identity is used for identifying a broadcast MRB.

In one embodiment, the DRB-Identity is used for identifying a DRB.

In one embodiment, the DRB-Identity is an integer no less than 1 and no greater than 32.

In one embodiment, the MRB-Identity is an integer no less than 1 and no greater than 32.

In one embodiment, the DRB-Identity is an integer no less than 1 and no greater than 64.

In one embodiment, the MRB-Identity is an integer no less than 1 and no greater than 64.

In one embodiment, the DRB-Identity is an integer no less than 1 and no greater than 16.

In one embodiment, the MRB-Identity is an integer no less than 1 and no greater than 16.

In one embodiment, the first bearer is a first-type DRB, while the second bearer is a first-type MRB.

In one embodiment, the first bearer is a first-type MRB, while the second bearer is a first-type DRB.

In one embodiment, the first-type DRB is a DRB.

In one embodiment, the first-type DRB is a DRB that can be used for SDT.

In one embodiment, the first-type DRB is a DRB that can be used for MT-SDT.

In one embodiment, the first-type DRB is a DRB that can be used for MO-SDT.

In one embodiment, the first-type DRB is a DRB that can be used for receiving downlink data in an RRC Inactive state.

In one embodiment, the first-type DRB is a DRB that can be used for transmitting uplink data or receiving downlink data in an RRC Inactive state.

In one embodiment, the first-type MRB is an MRB.

In one embodiment, the first-type MRB is an MRB that can be used for receiving MBS in the RRC Inactive state.

In one embodiment, CRC of the first signaling is scrambled by the first RNTI.

In one embodiment, the first signaling is indicated by the first RNTI.

In one embodiment, the first signaling is addressed to the first RNTI.

In one embodiment, the phrase that the first RNTI is related to the first bearer means: if the first bearer is an MRB, the first RNTI is an RNTI in a first candidate RNTI set, or if the first bearer is a DRB, the first RNTI is an RNTI in a second candidate RNTI set.

In one embodiment, any RNTI in the first candidate RNTI set belongs to multiple cells.

In one embodiment, any RNTI in the first candidate RNTI set belongs to one cell.

In one embodiment, any RNTI in the first candidate RNTI set is valid within one cell.

In one embodiment, any RNTI in the first candidate RNTI set is associated with MBS.

In one embodiment, any RNTI in the first candidate RNTI set is used for receiving MBS scheduling.

In one embodiment, any RNTI in the first candidate RNTI set is used for monitoring MBS scheduling.

In one embodiment, any RNTI in the first candidate RNTI set is used for broadcast PDSCH scheduling.

In one embodiment, any RNTI in the first candidate RNTI set is used for scrambling CRC of physical-layer scheduling information of MBS.

In one embodiment, any RNTI in the second candidate RNTI set is used for receiving SDT scheduling.

In one embodiment, any RNTI in the second candidate RNTI set is used for monitoring MT-SDT scheduling.

In one embodiment, any RNTI in the second candidate RNTI set is used for monitoring MO-SDT scheduling.

In one embodiment, any RNTI in the second candidate RNTI set is used for PDSCH scheduling.

In one embodiment, any RNTI in the second candidate RNTI set is used for PUSCH scheduling.

In one embodiment, any RNTI in the second candidate RNTI set is used for scrambling CRC of physical-layer scheduling information of SDT.

In one embodiment, any RNTI in the second candidate RNTI set is used for PDSCH scheduling or PUSCH scheduling.

In one embodiment, the first candidate RNTI set comprises a G-RNTI.

In one embodiment, the first candidate RNTI set comprises a MCCH-RNTI.

In one embodiment, the first candidate RNTI set comprises a G-CS-RNTI.

In one embodiment, the first candidate RNTI set only comprises a G-RNTI.

In one embodiment, the first candidate RNTI set comprises at least one RNTI other than a G-RNTI.

In one embodiment, the first candidate RNTI set comprises at least one G-RNTI.

In one embodiment, the first candidate RNTI set comprises only one G-RNTI.

In one embodiment, the first candidate RNTI set comprises one or more G-RNTIs.

In one embodiment, the first candidate RNTI set does not comprise a MCCH-RNTI.

In one embodiment, the first candidate RNTI set does not comprise a P-RNTI.

In one embodiment, the first candidate RNTI set does not comprise a System RNTI (SI-RNTI).

In one embodiment, the first candidate RNTI set does not comprise a Random Access RNTI (RA-RNTI).

In one embodiment, the first candidate RNTI set does not comprise an MsgB-RNTI.

In one embodiment, the first candidate RNTI set comprises an MsgB-RNTI.

In one embodiment, the G-RNTI is configured by MBS-SessionInfo.

In one embodiment, the G-RNTI is configured by a G-RNTI-Config.

In one embodiment, the G-RNTI is configured by a G-CS-RNTI.

In one embodiment, the second candidate RNTI set comprises a C-RNTI.

In one embodiment, the second candidate RNTI set comprises a CS-RNTI.

In one embodiment, the second candidate RNTI set comprises a MCS-C-RNTI.

In one embodiment, the second candidate RNTI set comprises an MsgB-RNTI.

In one embodiment, the second candidate RNTI set comprises a TC-RNTI.

In one embodiment, the second candidate RNTI set comprises a CG-RNTI

In one embodiment, the second candidate RNTI set only comprises a C-RNTI.

In one embodiment, the second candidate RNTI set comprises at least one RNTI other than a C-RNTI.

In one embodiment, the second candidate RNTI set does not comprise a P-RNTI.

In one embodiment, the second candidate RNTI set does not comprise a SI-RNTI.

In one embodiment, the second candidate RNTI set does not comprise a RA-RNTI.

In one embodiment, the second candidate RNTI set does not comprise an MsgB-RNTI.

### Embodiment 2

Embodiment 2 illustrates a schematic diagram of a network architecture according to one embodiment of the present application, as shown in FIG. 2. FIG. 2 illustrates a network architecture 200 of 5G New Radio (NR)/Long-Term Evolution (LTE)/Long-Term Evolution Advanced (LTE-A) systems. The 5G NR/LTE/LTE-A network architecture 200 may be called a 5G System/Evolved Packet System (5GS/EPS) 200 or other suitable terminology. The 5GS/EPS 200 may comprise a UE 201, a RAN 202, a 5G Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The RAN comprises a node 203 and other nodes 204. The node 203 provides UE 201 oriented user plane and control plane terminations. The node 203 may be connected to other nodes 204 via an Xn/X2 interface (for example, backhaul). The node 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The node 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The node 203 is connected to the 5GC/EPC210 via an S1/NG interface. The 5GC/EPC210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 201 is a UE.

In one embodiment, the node 203 corresponds to the second node in the present application.

In one embodiment, the node 203 is a BaseStation (BS).

In one embodiment, the node 203 is a Base Transceiver Station (BTS).

In one embodiment, the node 203 is a NodeB (NB).

In one embodiment, the node 203 is a gNB.

In one embodiment, the node 203 is an eNB.

In one embodiment, the node 203 is an ng-eNB.

In one embodiment, the node 203 is an en-gNB.

In one embodiment, the node 203 is a UE.

In one embodiment, the node 203 is a relay.

In one embodiment, the node 203 is a Gateway.

In one embodiment, the UE supports transmissions in Non-Terrestrial Network (NTN).

In one embodiment, the UE supports transmissions in Terrestrial Network (TN).

In one embodiment, the UE supports transmissions in large-delay-difference networks.

In one embodiment, the UE supports Dual Connection (DC) transmissions.

In one embodiment, the UE comprises a mobile terminal, or the UE comprises an aircraft, or the UE comprises a vehicle-mounted terminal, or the UE comprises a vessel, or the UE comprises an IoT terminal, the UE comprises an IIoT terminal, or the UE comprises a device supporting transmission with low latency and high reliability, or the UE comprises a piece of test equipment, or the UE comprises a signaling test instrument.

In one embodiment, the base station is a BS, or the base station is a Base Transceiver Station (BTS), or the base station is a NodeB (NB), or the base station is a gNB, or the base station is an eNB, or the base station is an ng-eNB, or the base station is an en-gNB.

In one embodiment, the base station comprises test equipment, or the base station comprises a signaling test instrument, or the base station comprises satellite equipment, or the base station comprises a flight platform, or the base station comprises a Marco Cellular base station, or the base station comprises a Micro Cell base station, or the base station comprises a Pico Cell base station, or the base station comprises a Femtocell.

In one embodiment, the base station supports transmissions in NTN.

In one embodiment, the base station supports transmissions in large-delay-difference networks.

In one embodiment, the base station supports transmissions in TN.

In one embodiment, the base station comprises a base station device supporting large time-delay difference.

In one embodiment, the base station comprises a Transmitter Receiver Point (TRP).

In one embodiment, the base station comprises a Centralized Unit (CU).

In one embodiment, the base station comprises a Distributed Unit (DU).

In one embodiment, the base station comprises an Integrated Access and Backhaul-node (IAB-node).

In one embodiment, the base station comprises an IAB-donor.

In one embodiment, the base station comprises an IAB-donor-CU.

In one embodiment, the base station comprises an IAB-donor-DU.

In one embodiment, the base station comprises an IAB-DU.

In one embodiment, the base station comprises an IAB-MT.

In one embodiment, the relay comprises a L3 relay.

In one embodiment, the relay comprises a L2 relay.

In one embodiment, the relay comprises a Router.

In one embodiment, the relay comprises an Exchanger.

In one embodiment, the relay comprises a UE.

In one embodiment, the relay comprises a base station.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 is represented by three layers, namely, layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between the UE and the gNB via the PHY 301. The L2 305 comprises a Medium Access Control (MAC) sublayer 302, a Radio Link Control (RLC) sublayer 303 and a Packet Data Convergence Protocol (PDCP) sublayer 304. The PDCP sublayer 304 provides multiplexing among variable radio bearers and logical channels. The PDCP sublayer 304 provides security by encrypting a packet and provides support for inter-cell handover. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling. The radio protocol architecture in the user plane 350 comprises the L1 layer and the L2 layer. In the user plane 350, the radio protocol architecture used for a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics.

In one embodiment, the radio protocol architecture in FIG. 3 is applicable to the first node in the present application.

In one embodiment, the radio protocol architecture in FIG. 3 is applicable to the second node in the present application.

In one embodiment, the first message in the present application is generated by the RRC306.

In one embodiment, the first message in the present application is generate by the MAC302 or the MAC352.

In one embodiment, the first message in the present application is generated by the PHY301 or the PHY351.

In one embodiment, the first signaling in the present application is generated by the PHY301 or the PHY351.

In one embodiment, the second message in the present application is generated by the RRC306.

In one embodiment, the second message in the present application is generated by the MAC302 or the MAC352.

In one embodiment, the second message in the present application is generated by the PHY301 or the PHY351.

In one embodiment, the third message in the present application is generated by the RRC306.

In one embodiment, the third message in the present application is generated by the MAC302 or the MAC352.

In one embodiment, the third message in the present application is generated by the PHY301 or the PHY351.

In one embodiment, the fourth message in the present application is generated by the RRC306.

In one embodiment, the fourth message in the present application is generated by the MAC302 or the MAC352.

In one embodiment, the fourth message in the present application is generated by the PHY301 or the PHY351.

### Embodiment 4

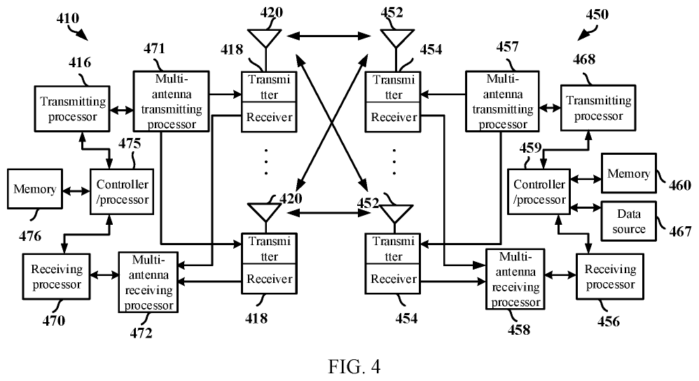

Embodiment 4 illustrates a schematic diagram of a first communication device and a second communication device according to the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also responsible for a retransmission of a lost packet, and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping of signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

Ina transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also in charge of a retransmission of a lost packet and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 first converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with a memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory. The at least one memory comprises computer program codes; the at least one memory and the computer program codes are configured to be used in collaboration with the at least one processor. The first communication device 450 at least receives a first message, the first message indicating at least a first bearer; and as a response to receiving the first message, enters or stays in an RRC Inactive state; and receives a first signaling and a second message while transmitting data via the first bearer in the RRC Inactive state, the first signaling comprising scheduling information of a first channel, and at least the second message being transmitted on the first channel, the second message being used to trigger data transmission via a second bearer; herein, one of the first bearer and the second bearer is an MRB while the other is a DRB; the first signaling is scrambled by a first RNTI; the first RNTI is related to the first bearer; if the first bearer is an MRB, the first RNTI is an RNTI in a first candidate RNTI set, or if the first bearer is a DRB, the first RNTI is an RNTI in a second candidate RNTI set; the first candidate RNTI set comprises at least a G-RNTI, and the second candidate RNTI set comprises at least a C-RNTI.

In one embodiment, the first communication device 450 comprises a memory that stores computer readable instruction program, the computer readable instruction program generates an action when executed by at least one processor, which includes: receiving a first message, the first message indicating at least a first bearer; and as a response to receiving the first message, entering or staying in an RRC Inactive state; and receiving a first signaling and a second message while transmitting data via the first bearer in the RRC Inactive state, the first signaling comprising scheduling information of a first channel, and at least the second message being transmitted on the first channel, the second message being used to trigger data transmission via a second bearer; herein, one of the first bearer and the second bearer is an MRB while the other is a DRB; the first signaling is scrambled by a first RNTI; the first RNTI is related to the first bearer; if the first bearer is an MRB, the first RNTI is an RNTI in a first candidate RNTI set, or if the first bearer is a DRB, the first RNTI is an RNTI in a second candidate RNTI set; the first candidate RNTI set comprises at least a G-RNTI, and the second candidate RNTI set comprises at least a C-RNTI.

In one embodiment, the second communication device 410 comprises at least one processor and at least one memory. The at least one memory comprises computer program codes; the at least one memory and the computer program codes are configured to be used in collaboration with the at least one processor. The second communication device 410 at least transmits a first message, the first message indicating at least a first bearer; and transmits a first signaling and a second message, the first signaling comprising scheduling information of a first channel, and at least the second message being transmitted on the first channel, the second message being used to trigger data transmission via a second bearer; herein, as a response to the first message being received, a receiver receiving the first message enters or stays in an RRC Inactive state; the first signaling and the second message are received by the receiver receiving the first message while transmitting data via the first bearer in the RRC Inactive state; one of the first bearer and the second bearer is an MRB while the other is a DRB; the first signaling is scrambled by a first RNTI; the first RNTI is related to the first bearer; if the first bearer is an MRB, the first RNTI is an RNTI in a first candidate RNTI set, or if the first bearer is a DRB, the first RNTI is an RNTI in a second candidate RNTI set; the first candidate RNTI set comprises at least a G-RNTI, and the second candidate RNTI set comprises at least a C-RNTI.

In one embodiment, the second communication device 410 comprises a memory that stores computer readable instruction program, the computer readable instruction program generates an action when executed by at least one processor, which includes: transmitting a first message, the first message indicating at least a first bearer; and transmitting a first signaling and a second message, the first signaling comprising scheduling information of a first channel, and at least the second message being transmitted on the first channel, the second message being used to trigger data transmission via a second bearer; herein, as a response to the first message being received, a receiver receiving the first message enters or stays in an RRC Inactive state; the first signaling and the second message are received by the receiver receiving the first message while transmitting data via the first bearer in the RRC Inactive state; one of the first bearer and the second bearer is an MRB while the other is a DRB; the first signaling is scrambled by a first RNTI; the first RNTI is related to the first bearer; if the first bearer is an MRB, the first RNTI is an RNTI in a first candidate RNTI set, or if the first bearer is a DRB, the first RNTI is an RNTI in a second candidate RNTI set; the first candidate RNTI set comprises at least a G-RNTI, and the second candidate RNTI set comprises at least a C-RNTI.

In one embodiment, the antenna 452, the receiver 454, the receiving processor 456, and the controller/processor 459 are used to receive a first message; at least one of the antenna 420, the transmitter 418, the transmitting processor 416, or the controller/processor 475 is used to transmit a first message.

In one embodiment, the antenna 452, the receiver 454, the receiving processor 456, and the controller/processor 459 are used to receive a first signaling; at least one of the antenna 420, the transmitter 418, the transmitting processor 416, or the controller/processor 475 is used to transmit a first signaling.

In one embodiment, the antenna 452, the receiver 454, the receiving processor 456, and the controller/processor 459 are used to receive a second message; at least one of the antenna 420, the transmitter 418, the transmitting processor 416, or the controller/processor 475 is used to transmit a second message.

In one embodiment, the antenna 452, the transmitter 454, the transmitting processor 468, and the controller/processor 459 are used to transmit a third message; at least one of the antenna 420, the receiver 418, the receiving processor 470, or the controller/processor 475 is used to receive a third message.

In one embodiment, the antenna 452, the receiver 454, the receiving processor 456, and the controller/processor 459 are used to receive a fourth message; at least one of the antenna 420, the transmitter 418, the transmitting processor 416, or the controller/processor 475 is used to transmit a fourth message.

In one embodiment, the first communication device 450 corresponds to the first node in the present application.

In one embodiment, the second communication device 410 corresponds to the second node in the present application.

In one embodiment, the first communication device 450 is a UE.

In one embodiment, the first communication device 450 is a UE supporting large delay difference.

In one embodiment, the first communication device 450 is a UE supporting NTN.

In one embodiment, the first communication device 450 is an aircraft.

In one embodiment, the first communication device 450 is capable of positioning.

In one embodiment, the first communication device 450 is incapable of positioning.

In one embodiment, the first communication device 450 is a UE supporting TN.

In one embodiment, the second communication device 410 is a base station (gNB/eNB/ng-eNB).

In one embodiment, the second communication device 410 is a base station supporting large delay difference.

In one embodiment, the second communication device 410 is a base station supporting NTN.

In one embodiment, the second communication device 410 is satellite equipment.

In one embodiment, the second communication device 410 is a flight platform.

In one embodiment, the second communication device 410 is a base station supporting TN.

### Embodiment 5

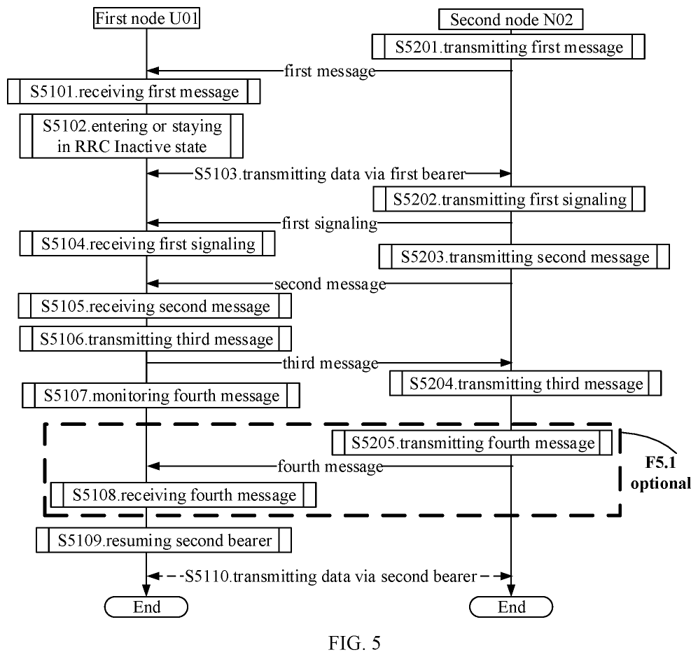

Embodiment 5 illustrates a flowchart of radio signal transmission according to one embodiment of the present application, as shown in FIG. 5. It should be particularly noted that the sequence illustrated herein does not set any limit to the signal transmission order or implementation order in the present application.

The first node U01 receives a first message in step S5101, the first message indicating at least a first bearer; and in step S5102, as a response to receiving the first message, enters or stays in an RRC Inactive state; and transmits data via the first bearer in the RRC Inactive state in step S103; receives a first signaling while transmitting data via the first bearer in the RRC Inactive state in step S5104; and receives a second message while transmitting data via the first bearer in the RRC Inactive state in step S5105; and transmits a third message as a response to receiving the second message in step S5106, the third message being used for an RRC connection resume procedure; and in step S5107, monitors a fourth message as a response to the third message being transmitted; receives a fourth message in step S5108; resumes the second bearer along with the RRC connection resume procedure in step S5109; and transmits data via the second bearer in step S5110.

The second node N02 transmits the first message in step S5201; transmits the first signaling in step S5202; and transmits the second message in step S5203; transmits the third message in step S5204; and transmits the fourth message in step S5205.

In Embodiment 5, the first signaling comprises scheduling information of a first channel, and at least the second message is transmitted on the first channel, the second message being used to trigger data transmission via a second bearer; one of the first bearer and the second bearer is an MRB while the other is a DRB; the first signaling is scrambled by a first RNTI; the first RNTI is related to the first bearer; if the first bearer is an MRB, the first RNTI is an RNTI in a first candidate RNTI set, or if the first bearer is a DRB, the first RNTI is an RNTI in a second candidate RNTI set; the first candidate RNTI set comprises at least a G-RNTI, and the second candidate RNTI set comprises at least a C-RNTI; the fourth message belongs to the RRC connection resume procedure.

In one embodiment, the first node U01 is a UE.

In one embodiment, the first node U01 is a terminal.

In one embodiment, the first node U01 is a piece of test equipment.

In one embodiment, the first node U01 is a relay device.

In one embodiment, the second node N02 is a base station.

In one embodiment, the second node N02 is a relay device.

In one embodiment, the second node N02 is an IAB node.

In one embodiment, a receiver receiving the third message and a transmitter transmitting the first signaling are the same.

In one embodiment, the third message is an RRC message.

In one embodiment, the third message comprises an RRC message.

In one embodiment, the third message comprises at least one RRC IE.

In one embodiment, the third message comprises at least one RRC field.

In one embodiment, the third message is a downlink signaling.

In one embodiment, the third message comprises an RRCResumeRequest message or an RRCResumeRequest1 message.

In one embodiment, the third message comprises an RRCConnectionResumeRequest message or an RRCEarlyDataRequest message.

In one embodiment, a logical channel of the third message is a CCCH.

In one embodiment, a logical channel of the third message is a DCCH.

In one embodiment, a signaling radio bearer for the third message is a SRB0.

In one embodiment, a signaling radio bearer for the third message is a SRB1.

In one embodiment, a signaling radio bearer for the third message is a SRB2.

In one embodiment, the third message is used for notifying that the second node N02 shall transmit data via the second bearer.

In one embodiment, the third message is used to determine that data is transmitted via the second bearer.

In one embodiment, as a response to receiving the second message, the second bearer is resumed.

In one embodiment, as a response to receiving the second message, an RRC connection resume procedure is resumed; a third message is transmitted in the RRC connection resume procedure.

In one embodiment, as a response to receiving the second message, an RRC connection resume procedure is resumed, and resumeCause is set to a first character string.

In one subembodiment, names of the first character string include at least one of MT or mt or SDT or sdt or inactive or data or transmission.

In one subembodiment, the first character string comprises a MT-SDT.

In one subembodiment, the first character string comprises a mt-sdt.

In one embodiment, as a response to receiving the second message, an RRC connection resume procedure is resumed, and resumeCause is set to a second character string.

In one subembodiment, the second character string is one of a mps-PriorityAccess, or a mcs-PriorityAccess, or a highPriorityAccess, or a mt-Access.

In one subembodiment, the second character string is a mps-PriorityAccess.

In one subembodiment, the second character string is a mcs-PriorityAccess.

In one subembodiment, the second character string is a highPriorityAccess.

In one subembodiment, the second character string is a mt-Access.

In one embodiment, if resumeCause is set to the first character string, the second bearer is resumed in the RRC Inactive state.

In one embodiment, if resumeCause is set to the second character string, only when an RRCResume message is received will the second bearer be resumed.

In one embodiment, the fourth message is a downlink signaling.

In one embodiment, the fourth message is an RRC message.

In one embodiment, the fourth message comprises an RRC message.

In one embodiment, a logical channel of the fourth message is a CCCH.

In one embodiment, a logical channel of the fourth message is a DCCH.

In one embodiment, a signaling radio bearer for the fourth message is a SRB0.

In one embodiment, a signaling radio bearer for the fourth message is a SRB1.

In one embodiment, a signaling radio bearer for the fourth message is a SRB2.

In one embodiment, the fourth message is an RRC response to the third message.

In one embodiment, the fourth message is triggered by the third message.

In one embodiment, the fourth message and the third message both belong to the RRC connection resume procedure.

In one embodiment, the action of listening over a fourth message comprises: determining whether the fourth message is received by listening over a PDCCH.

In one embodiment, the action of listening over a fourth message comprises: determining whether the fourth message is received in an RRC layer.

In one embodiment, the action of listening over a fourth message comprises: determining whether the fourth message is received.

In one embodiment, the action of listening over a fourth message comprises: detecting the fourth message.

In one embodiment, the sentence of “resuming the second bearer along with the RRC connection resume procedure” comprises: resuming the second bearer in the RRC connection resume procedure.

In one embodiment, the sentence of “resuming the second bearer along with the RRC connection resume procedure” comprises: resuming the second bearer along with the third message.

In one subembodiment, the fourth message comprises one of an RRCRelease message, or an RRCResume message, or an RRCReject message, or an RRCSetup message.

In one subembodiment, the fourth message comprises one of an RRCConnectionResume message, or an RRCEarlyDataComplete message, or an RRCConnectionReject message, or an RRCConnectionSetup message, or an RRCConnectionRelease message.

In one subembodiment, within a time interval from the third message being transmitted to the fourth message being received, the first node U01 receives at least one downlink datum via the first bearer.

In one subembodiment, within a time interval from the third message being transmitted to the fourth message being received, the first node U01 transmits at least one downlink datum via the first bearer.

In one subembodiment, after the third message is completely configured, and before the third message is delivered to a lower layer, the second bearer is resumed.

In one subembodiment, after the third message is completely configured, and before the third message is transmitted, the second bearer is resumed.

In one subembodiment, as a response to the third message being transmitted, the second bearer is resumed.

In one subembodiment, before the third message is transmitted, the second bearer is resumed.

In one subembodiment, after the third message is transmitted, and before the fourth message is received, the second bearer is resumed.

In one subembodiment, after the third message is transmitted, as a response to receiving a PDCCH scrambled by the first identifier, the second bearer is resumed.

In one subembodiment, transmitting an Msg3 in a random access procedure, the Msg3 comprising a CCCH SDU, the CCCH SDU comprising the third message; and as a response to the Msg3 being transmitted, receiving UE Contention Resolution Identity in the MAC CE, the UE Contention Resolution Identity in the MAC CE comprising at least part of the CCCH SDU; and as a response to receiving the UE Contention Resolution Identity in the MAC CE, resuming the second bearer.

In one subembodiment, transmitting an MsgA in a random access procedure, the MsgA comprising a CCCH SDU, the CCCH SDU comprising the third message; and as a response to the MsgA being transmitted, receiving an MsgB, the MsgB comprising a successRAR MAC subPDU, the successRAR MAC subPDU comprising at least part of the CCCH SDU; and as a response to receiving the UE Contention Resolution Identity in the MAC CE, resuming the second bearer.

In one subembodiment, transmitting the third message in a random access procedure, and as a response to the random access procedure being successfully completed, the second bearer is resumed.

In one subembodiment, transmitting the third message in a random access procedure, and as a response to the random access procedure being successfully completed, the second bearer is resumed.

In one embodiment, the sentence of “resuming the second bearer along with the RRC connection resume procedure” comprises: resuming the second bearer along with the fourth message.

In one subembodiment, the fourth message comprises an RRCResume message.

In one subembodiment, the fourth message comprises an RRCConnectionResume message or an RRCEarlyDataComplete message.

In one subembodiment, within at least one slot after the fourth message is received, the first node U01 receives at least one downlink datum via the first bearer.

In one subembodiment, within at least one slot after the fourth message is received, the first node U01 transmits at least one downlink datum via the first bearer.

In one subembodiment, after the fourth message is received, the second bearer is resumed.

In one subembodiment, as a response to the fourth message being received, the second bearer is resumed.

In one embodiment, if the second message indicates that data is to be transmitted via the second bearer in the RRC Inactive state, the second bearer is resumed, along with the third message.

In one embodiment, if the second message indicates that data is to be transmitted via the second bearer in the RRC Inactive state, the second bearer is resumed, along with the fourth message.

In one embodiment, if the second message indicates that data is to be transmitted via the second bearer in the RRC Connected state, the second bearer is resumed, along with the fourth message.

In one embodiment, the step S5109 is taken before the step S5106.

In one embodiment, the step S5109 is taken after the step S5106, and the step S5109 is taken before the step S5107.

In one embodiment, the dotted-line box F5.1 is optional.

In one embodiment, the dotted-line box F5.1 exists.

In one embodiment, the dotted-line box F5.1 doesn't exist.

In one embodiment, the fourth message is received.

In one embodiment, the fourth message is not received.

### Embodiment 6

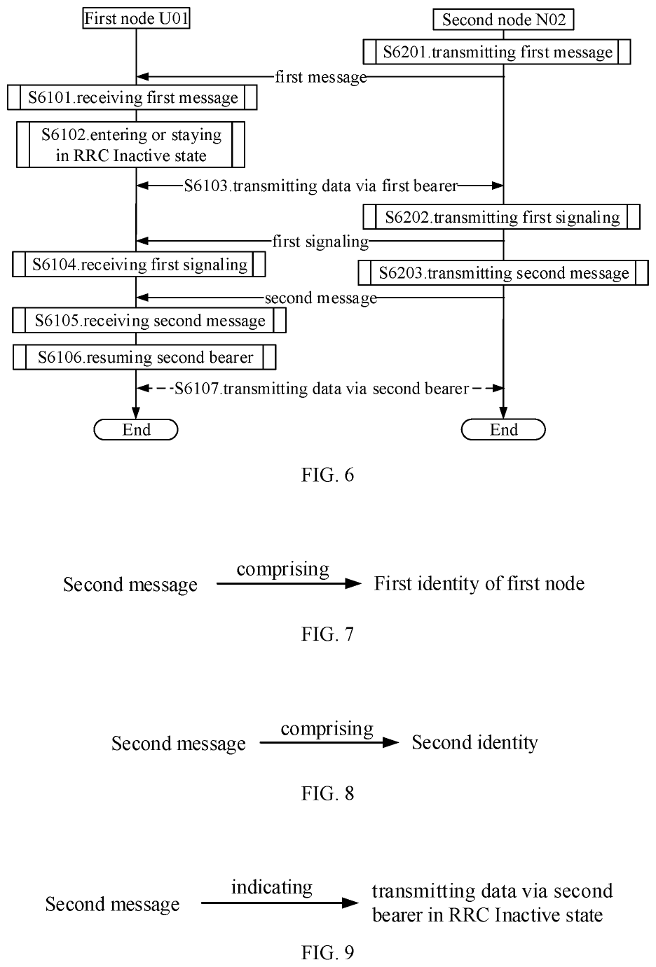

Embodiment 6 illustrates a flowchart of signal transmission according to another embodiment of the present application, as shown in FIG. 6. It should be particularly noted that the sequence illustrated herein does not set any limit to the signal transmission order or implementation order in the present application.

The first node U01 receives a first message in step S6101, the first message indicating at least a first bearer; and in step S6102, as a response to receiving the first message, enters or stays in an RRC Inactive state; and transmits data via the first bearer in the RRC Inactive state in step S6103; receives a first signaling while transmitting data via the first bearer in the RRC Inactive state in step S6104; and receives a second message while transmitting data via the first bearer in the RRC Inactive state in step S6105; and resumes the second bearer as a response to receiving the second message in step S6106; and transmits data via the second bearer in step S6107.

The second node N02 transmits the first message in step S6201; transmits the first signaling in step S6202; and transmits the second message in step S6203.

In Embodiment 6, the first signaling comprises scheduling information of a first channel, and at least the second message is transmitted on the first channel, the second message being used to trigger data transmission via a second bearer; one of the first bearer and the second bearer is an MRB while the other is a DRB; the first signaling is scrambled by a first RNTI; the first RNTI is related to the first bearer; if the first bearer is an MRB, the first RNTI is an RNTI in a first candidate RNTI set, or if the first bearer is a DRB, the first RNTI is an RNTI in a second candidate RNTI set; the first candidate RNTI set comprises at least a G-RNTI, and the second candidate RNTI set comprises at least a C-RNTI; the action of receiving the second message does not trigger the RRC connection resume procedure.

In one embodiment, within a time interval between the action of receiving the second message and resuming the second bearer, the first node U01 does not transmit an RRCResumeRequest message, or an RRCResumeRequest1 message, or the RRCConnectionResumeRequest message, or the RRCEarlyDataRequest message.

In one embodiment, the action of receiving the second message does not trigger an RRCResumeRequest message, or an RRCResumeRequest1 message, or the RRCConnectionResumeRequest message, or the RRCEarlyDataRequest message.

In one embodiment, the action of receiving the second message is used to trigger the action of resuming the second bearer.

In one embodiment, after the second bearer is resumed, at least one downlink datum is received via the second bearer.

In one embodiment, after the second bearer is resumed, at least one downlink datum is received via the second bearer in an RRC Inactive state.

In one embodiment, the second bearer being resumed is used to determine that data is transmitted via the second bearer.

### Embodiment 7

Embodiment 7 illustrates a schematic diagram of a second message comprising a first identity of a first node according to one embodiment of the present application, as shown in FIG. 7.

In Embodiment 7, the second message comprises a first identity of the first node, where the first identity of the first node is unique in at least one cell; the first bearer is an MRB, and the first RNTI is an RNTI in the first candidate RNTI set.

In one embodiment, the first node receives a first message, the first message indicating at least a first bearer; and as a response to receiving the first message, enters or stays in an RRC Inactive state; and receives a first signaling and a second message while transmitting data via the first bearer in the RRC Inactive state, the first signaling comprising scheduling information of a first channel, and at least the second message being transmitted on the first channel, the second message being used to trigger data transmission via a second bearer; herein, the second message comprises a first identity of the first node, the first identity of the first node being unique in at least one cell; the first bearer is an MRB while the second bearer is a DRB; the first signaling is scrambled by a first RNTI; the first RNTI is an RNTI in a first candidate RNTI set; the first candidate RNTI set comprises at least a G-RNTI.

In one embodiment, the first identity of the first node is used for recognizing the first node in an RRC Inactive state.

In one embodiment, the at least one cell only includes one cell.

In one embodiment, the at least one cell includes one cell or multiple cells.

In one embodiment, the at least one cell is one cell.

In one embodiment, the at least one cell is a Radio Access Network-based Notification Area (RAN-based Notification Area, i.e., RNA).

In one embodiment, the at least one cell is one Tracking Area (TA).

In one embodiment, the at least one cell is pre-defined.

In one embodiment, the at least one cell is pre-configured.

In one embodiment, the phrase of the first identity of the first node being unique in at least one cell means:

within the at least one cell, the first identity of the first node is not used by other UE.

In one embodiment, the phrase of the first identity of the first node being unique in at least one cell means: there doesn't exist an identity of a UE that is the same as the first identity of the first node.

In one embodiment, the phrase of the first identity of the first node being unique in at least one cell means: within the at least one cell, the first identity of the first node is used for uniquely identifying the first node.

In one embodiment, the second message comprises an identity/identities of at least one UE, where an identity of a UE is used to indicate a UE, the at least one UE including the first node.

In one embodiment, an identity of a UE includes: one of an NG-5G-S-TMSI, or an I-RNTI-Value, or a ShortI-RNTI-Value.

In one embodiment, an identity of a UE includes: one of a System Architecture Evolution (SAE) Temporary Mobile Station Identifier (S-TMSI), or an NG-5G-S-TMSI-r15, or an I-RNTI-r15.

In one embodiment, an identity of a UE includes 40 bits, or 48 bits, or 24 bits, or 16 bits.

In one embodiment, the second message comprises a PagingRecord field, the PagingRecord field comprising at least a former of a ue-Identity field and an accessType field; the ue-Identity field comprising the first identity of the first node.

In one embodiment, the second message comprises a PagingRecord field, the PagingRecord field comprising at least a former of a ue-Identity field and an accessType field; the ue-Identity field comprising a PagingUE-Identity field, the PagingUE-Identity field indicating the first identity of the first node.

In one embodiment, the second message comprises an RRC field, the RRC field comprising the first identity of the first node.

In one subembodiment, names of the RRC field include PagingUE-Identity.

In one subembodiment, names of the RRC field include PagingRecord.

In one subembodiment, the RRC field is a PagingUE-Identity field.

In one subembodiment, the RRC field is a PagingRecord field.

In one subembodiment, the RRC field indicates the first identity of the first node.

In one subembodiment, the RRC field is configured as the first identity of the first node.

In one embodiment, the first identity of the first node comprises an NG-5G-S-TMSI of the first node.

In one embodiment, the first identity of the first node comprises an I-RNTI-Value of the first node.

In one embodiment, the first identity of the first node comprises a ShortI-RNTI-Value of the first node.

In one embodiment, the first identity of the first node comprises an S-TMSI of the first node.

In one embodiment, the first identity of the first node comprises an IMSI of the first node.

In one embodiment, the first identity of the first node comprises an NG-5G-S-TMSI-r15 of the first node.

In one embodiment, the first identity of the first node comprises an I-RNTI-r15 of the first node.

In one embodiment, the first identity of the first node is used for recognizing UE context of a UE in an RRC Inactive state.

In one embodiment, the first identity of the first node comprises a 5G S-Temporary Mobile Subscription Identifier (5G-S-TMSI), the 5G-S-TMSI being provided by 5GC, and the first identity of the first node being unique in a Tracking Area.

In one embodiment, the first identity of the first node comprises a bit string.

In one embodiment, the first identity of the first node comprises 40 bits.

In one embodiment, the first identity of the first node comprises 48 bits.

In one embodiment, the first identity of the first node comprises 24 bits.

In one embodiment, the first identity of the first node comprises 16 bits.

### Embodiment 8

Embodiment 8 illustrates a schematic diagram of a second message comprising a second identity according to one embodiment of the present application.

In Embodiment 8, the second message comprises a second identity, the second identity being used to indicate a first MBS session, the first node being joined in the first MBS session; the first bearer is a DRB, and the first RNTI is an RNTI in the second candidate RNTI set.

In one embodiment, the first node receives a first message, the first message indicating at least a first bearer; and as a response to receiving the first message, enters or stays in an RRC Inactive state; and receives a first signaling and a second message while transmitting data via the first bearer in the RRC Inactive state, the first signaling comprising scheduling information of a first channel, and at least the second message being transmitted on the first channel, the second message being used to trigger data transmission via a second bearer; herein, the second message comprises a second identity, the second identity being used to indicate a first MBS session, the first node being joined in the first MBS session; the first bearer is a DRB while the second bearer is an MRB; the first signaling is scrambled by a first RNTI; the first RNTI is an RNTI in a second candidate RNTI set; the second candidate RNTI set comprises at least a C-RNTI.

In one embodiment, the first node determines according to the second identity that an MBS session is the first MBS session.

In one embodiment, the second identity is an index of the first MBS session.

In one embodiment, the second identity is an identity of the first MBS session.

In one embodiment, the second identity is an identifier of the first MBS session.

In one embodiment, the second identity is associated with the second bearer.

In one embodiment, the second identity is associated with a G-RNTI.

In one embodiment, the second bearer being configured is used to determine that the first node is joined in the first IVIES session.

In one embodiment, the first node transmits an MBS-InterestIndication message to the second node, and the MBS-InterestIndication message comprises the second identity being used to determine that the first node is joined in the first IVIES session.

In one embodiment, the second identity is a Temporary Mobile Group Identity (TMGI).

In one embodiment, the TMGI comprises a plmn-Id and a serviceId.

In one embodiment, the second identity indicates a Public Land Mobile Network (PLMN).

In one embodiment, the second identity indicates an index of a PLMN.

In one embodiment, the second identity indicates a serviceId.

In one embodiment, the first MBS session is an MBS broadcast session.

In one embodiment, the first MBS session is an MBS multicast session.

In one embodiment, the first MBS session is for at least one UE.

In one embodiment, the first MBS session is for one or more UEs.

In one embodiment, the first MBS session is for a group of UEs.

In one embodiment, the first MBS session is for a group of UEs joined in the first MBS session.

In one embodiment, the first MBS session is associated with a G-RNTI.

In one embodiment, the second identity is an identity of the first MBS session.

In one embodiment, the second identity is an identifier of the first MBS session.

In one embodiment, the first node determines the first MBS session according to the second identity.

In one embodiment, the second bearer being configured is used to indicate that the first node is joined in the first MBS session.

In one embodiment, the second bearer is used to indicate that the first node is joined in the first MB S session.

In one embodiment, the second message comprises an RRC field, and names of the RRC field include pagingGroupList; the RRC field comprises the second identity.

In one embodiment, the second message comprises an RRC field, the RRC field comprising the second identity.

In one subembodiment, names of the RRC field include PagingGroupList.

In one subembodiment, names of the RRC field include TMGI.

In one subembodiment, names of the RRC field include at least one of TMGI or List.

In one subembodiment, names of the RRC field include at least one of MBS or Session or List.

In one subembodiment, names of the RRC field include at least one of Group or List.

In one subembodiment, names of the RRC field include MBS-SessionInfoList.

In one embodiment, the second message comprises M1 TMGIs, the M1 TMGIs being associated with N1 first-type MRBs; as a response to receiving the second message, resuming the N1 first-type MRBs; the second bearer is one of the N1 first-type MRBs.

In one subembodiment, M1 is equal to the N1.

In one subembodiment, M1 is unequal to the N1.

In one subembodiment, any two TMGIs among the M1 TMGIs are associated with two different first-type MRBs of the N1 first-type MRBs.

In one subembodiment, any two first-type MRBs among the N1 first-type MRBs are associated with two different TMGIs of the M1 TMGIs.

In one subembodiment, a first-type MRB is one-to-one corresponding to a TMGI.

### Embodiment 9

Embodiment 9 illustrates a schematic diagram of a second message indicating data transmission via a second bearer in an RRC Inactive state according to one embodiment of the present application, as shown in FIG. 9.

In Embodiment 9, the second message indicates that data is to be transmitted via the second bearer in the RRC Inactive state.

In one embodiment, the phrase that the second message is used to trigger data transmission via a second bearer means: the second message is used to trigger data transmission via the second bearer in the RRC Inactive state.

In one embodiment, if the second message indicates that data is to be transmitted via the second bearer in the RRC Inactive state, as a response to receiving the second message, the second bearer is resumed; the action of receiving the second message does not trigger an RRC connection resume procedure.

In one embodiment, the second message explicitly indicates that data is transmitted via the second bearer in the RRC Inactive state.

In one embodiment, the second message implicitly indicates that data is transmitted via the second bearer in the RRC Inactive state.

### Embodiment 10

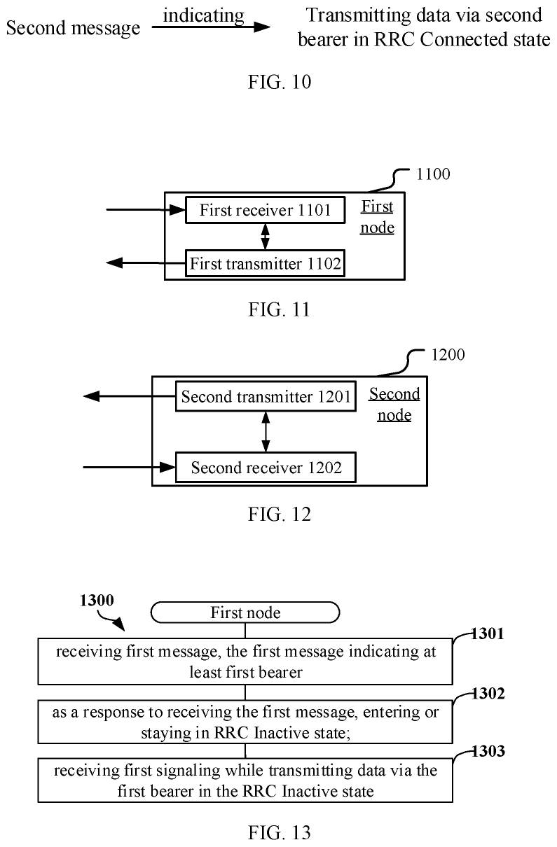

Embodiment 10 illustrates a schematic diagram of a second message indicating data transmission via a second bearer in an RRC Connected state according to one embodiment of the present application, as shown in FIG. 10.

In Embodiment 10, the second message indicates that data is to be transmitted via the second bearer in an RRC Connected state.

In one embodiment, the phrase that the second message is used to trigger data transmission via a second bearer means: the second message is used to trigger data transmission via the second bearer in an RRC Connected state.

In one embodiment, if the second message indicates that data is to be transmitted via the second bearer in an RRC Connected state, as a response to receiving the second message, the third message is transmitted, the third message being used for an RRC connection resume procedure; as a response to the third message being transmitted, a fourth message is monitored; and along with the RRC connection resume procedure, the second bearer is resumed; the fourth message belongs to the RRC connection resume procedure.

In one embodiment, the phrase that the second message indicates that data is to be transmitted via the second bearer in an RRC connected state comprises: as a response to receiving the second message, switching from an RRC Inactive state to the RRC Connected state, and then transmitting data via the second bearer.

In one embodiment, as a response to receiving the fourth message, the second bearer is resumed; herein, the fourth message is an RRCResume message.

In one embodiment, after receiving the fourth message, the second bearer is resumed.

In one embodiment, the second message explicitly indicates that data is transmitted via the second bearer in the RRC Connected state.

In one embodiment, the second message implicitly indicates that data is transmitted via the second bearer in the RRC Connected state.

### Embodiment 11

Embodiment 11 illustrates a structure block diagram of a processing device used in a first node according to one embodiment of the present application; as shown in FIG. 11. In FIG. 11, a processing device 1100 in the first node is comprised of a first receiver 1101 and a first transmitter 1102.

The first receiver 1101 receives a first message, the first message indicating at least a first bearer; and as a response to receiving the first message, enters or stays in an RRC Inactive state; and receives a first signaling and a second message while transmitting data via the first bearer in the RRC Inactive state, the first signaling comprising scheduling information of a first channel, and at least the second message being transmitted on the first channel, the second message being used to trigger data transmission via a second bearer;

In Embodiment 11, one of the first bearer and the second bearer is an MRB while the other is a DRB; the first signaling is scrambled by a first RNTI; the first RNTI is related to the first bearer; if the first bearer is an MRB, the first RNTI is an RNTI in a first candidate RNTI set, or if the first bearer is a DRB, the first RNTI is an RNTI in a second candidate RNTI set; the first candidate RNTI set comprises at least a G-RNTI, and the second candidate RNTI set comprises at least a C-RNTI.

In one embodiment, the first transmitter 1102, as a response to receiving the second message, transmits the third message, the third message being used for an RRC connection resume procedure; and the first receiver 1101, as a response to the third message being transmitted, monitors a fourth message; and the first processor, along with the RRC connection resume procedure, resumes the second bearer; herein, the fourth message belongs to the RRC connection resume procedure.

In one embodiment, the first processor is the first receiver 1101.

In one embodiment, the first processor is the first transmitter 1102.

In one embodiment, the first processor comprises at least one of the first receiver 1101 or the first transmitter 1102.

In one embodiment, the first receiver 1101 resumes the second bearer as a response to receiving the second message; the action of receiving the second message does not trigger an RRC connection resume procedure.

In one embodiment, the second message comprises a first identity of the first node, where the first identity of the first node is unique in at least one cell; the first bearer is an MRB, and the first RNTI is an RNTI in the first candidate RNTI set.

In one embodiment, the second message comprises a second identity, the second identity being used to indicate a first MBS session, the first node being joined in the first MBS session; the first bearer is a DRB, and the first RNTI is an RNTI in the second candidate RNTI set.

In one embodiment, the second message indicates that data is to be transmitted via the second bearer in the RRC Inactive state.

In one embodiment, the second message indicates that data is to be transmitted via the second bearer in an RRC Connected state.

In one embodiment, the first receiver 1101 comprises the antenna 452, the receiver 454, the multi-antenna receiving processor 458, the receiving processor 456, the controller/processor 459, the memory 460 and the data source 467 in FIG. 4 of the present application.

In one embodiment, the first receiver 1101 comprises the antenna 452, the receiver 454, the multi-antenna receiving processor 458 and the receiving processor 456 in FIG. 4 of the present application.

In one embodiment, the first receiver 1101 comprises the antenna 452, the receiver 454 and the receiving processor 456 in FIG. 4 of the present application.

In one embodiment, the first transmitter 1102 comprises the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1102 comprises the antenna 452, the transmitter 454, the multi-antenna transmitting processor 457 and the transmitting processor 468 in FIG. 4 of the present application.

In one embodiment, the first transmitter 1102 comprises the antenna 452, the transmitter 454 and the transmitting processor 468 in FIG. 4 of the present application.

### Embodiment 12

Embodiment 12 illustrates a structure block diagram of a processing device used in a second node according to one embodiment of the present application; as shown in FIG. 12. In FIG. 12, a processing device 1200 in a second node comprises a second transmitter 1201 and a second receiver 1202.

The second transmitter 1201 transmits a first message, the first message indicating at least a first bearer; and transmits a first signaling and a second message, the first signaling comprising scheduling information of a first channel, and at least the second message being transmitted on the first channel, the second message being used to trigger data transmission via a second bearer.

In Embodiment 12, as a response to the first message being received, a receiver receiving the first message enters or stays in an RRC Inactive state; the first signaling and the second message are received by the receiver receiving the first message while transmitting data via the first bearer in the RRC Inactive state; one of the first bearer and the second bearer is an MRB while the other is a DRB; the first signaling is scrambled by a first RNTI; the first RNTI is related to the first bearer; if the first bearer is an MRB, the first RNTI is an RNTI in a first candidate RNTI set, or if the first bearer is a DRB, the first RNTI is an RNTI in a second candidate RNTI set; the first candidate RNTI set comprises at least a G-RNTI, and the second candidate RNTI set comprises at least a C-RNTI.

In one embodiment, the second receiver 1202 receives a third message, the third message being used for an RRC connection resume procedure; and the second transmitter 1201, as a response to the third message being received, determines whether a fourth message is transmitted; herein, along with the RRC connection resume procedure, the second bearer is resumed; the fourth message belongs to the RRC connection resume procedure; the second message is used to trigger the third message.

In one embodiment, as a response to the second message being received by a receiver receiving the first message, the second bearer is resumed; the second message being received by the receiver receiving the first message does not trigger an RRC connection resume procedure.

In one embodiment, the second message comprises a first identity of a receiver receiving the first message, where the first identity of the receiver of the first message is unique in at least one cell; the first bearer is an MRB, and the first RNTI is an RNTI in the first candidate RNTI set.

In one embodiment, the second message comprises a second identity, the second identity being used to indicate a first MBS session, a receiver receiving the first message being joined in the first MBS session; the first bearer is a DRB, and the first RNTI is an RNTI in the second candidate RNTI set.

In one embodiment, the second message indicates that data is to be transmitted via the second bearer in the RRC Inactive state.

In one embodiment, the second message indicates that data is to be transmitted via the second bearer in an RRC Connected state.

In one embodiment, the second transmitter 1201 comprises the antenna 420, the transmitter 418, the multi-antenna transmitting processor 471, the transmitting processor 416, the controller/processor 475 and the memory 476 in FIG. 4 of the present application.

In one embodiment, the second transmitter 1201 comprises the antenna 420, the transmitter 418, the multi-antenna transmitting processor 471 and the transmitting processor 416 in FIG. 4 of the present application.

In one embodiment, the second transmitter 1201 comprises the antenna 420, the transmitter 418 and the transmitting processor 416 in FIG. 4 of the present application.

In one embodiment, the second receiver 1202 comprises the antenna 420, the receiver 418, the multi-antenna receiving processor 472, the receiving processor 470, the controller/processor 475 and the memory 476 in FIG. 4 of the present application.

In one embodiment, the second receiver 1102 comprises the antenna 420, the receiver 418, the multi-antenna receiving processor 472 and the receiving processor 470 in FIG. 4 of the present application.

In one embodiment, the second receiver 1202 comprises the antenna 420, the receiver 418 and the receiving processor 470 in FIG. 4 of the present application.

### Embodiment 13

Embodiment 13 illustrates a flowchart of transmission of a first message and a first signaling according to one embodiment of the present application, as shown in FIG. 13. In FIG. 13, each step represents a step, it should be particularly noted that the sequence order of each box herein does not imply a chronological order of steps marked respectively by these boxes.

In Embodiment 13, the first node in the present application receives a first message in step 1301, the first message indicating at least a first bearer; and as a response to receiving the first message, enters or stays in an RRC Inactive state in step 1302; and receives a first signaling while transmitting data via the first bearer in the RRC Inactive state in step 1303, the first signaling being used to trigger data transmission via a second bearer; herein, one of the first bearer and the second bearer is an MRB while the other is a DRB; the first signaling is scrambled by a first RNTI; the first RNTI is related to the first bearer; if the first bearer is an MRB, the first RNTI is an RNTI in a first candidate RNTI set, or if the first bearer is a DRB, the first RNTI is an RNTI in a second candidate RNTI set; the first candidate RNTI set comprises at least a G-RNTI, and the second candidate RNTI set comprises at least a C-RNTI.

In one embodiment, the first signaling comprises scheduling information of a first channel, and at least a second message is transmitted on the first channel.

In one embodiment, the first channel is a PUSCH.

In one embodiment, the first channel is a PDSCH.

In one embodiment, the first signaling is a field in DCI.

In one embodiment, the first signaling is a DCI.

In one embodiment, the first signaling indicates that data is transmitted via the second bearer.

In one embodiment, the first signaling indicates that data is transmitted via the second bearer in an RRC Inactive state.

In one embodiment, the first signaling indicates that data is transmitted via the second bearer in an RRC

Connected state.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IOT), RFID terminals, NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, which receives a first message, the first message indicating at least a first bearer; and as a response to receiving the first message, enters or stays in an RRC Inactive state; and receives a first signaling and a second message while transmitting data via the first bearer in the RRC Inactive state, the first signaling comprising scheduling information of a first channel, and at least the second message being transmitted on the first channel, the second message being used to trigger data transmission via a second bearer;
wherein one of the first bearer and the second bearer is an MRB while the other is a DRB; the first signaling is scrambled by a first RNTI; the first RNTI is related to the first bearer; if the first bearer is an MRB, the first RNTI is an RNTI in a first candidate RNTI set, or if the first bearer is a DRB, the first RNTI is an RNTI in a second candidate RNTI set; the first candidate RNTI set comprises at least a G-RNTI, and the second candidate RNTI set comprises at least a C-RNTI.

2. The first node according to claim 1, comprising:
a first transmitter, which transmits a third message as a response to receiving the second message, the third message being used for an RRC connection resume procedure;
the first receiver, which monitors a fourth message as a response to the third message being transmitted; and
a first processor, which resumes the second bearer along with the RRC connection resume procedure;
wherein the fourth message belongs to the RRC connection resume procedure.

3. The first node according to claim 1, comprising:
the first receiver, which resumes the second bearer as a response to receiving the second message; the action of receiving the second message does not trigger an RRC connection resume procedure.

4. The first node according to claim 1, wherein the second message comprises a first identity of the first node, where the first identity of the first node is unique in at least one cell; the first bearer is an MRB, and the first RNTI is an RNTI in the first candidate RNTI set.

5. The first node according to claim 1, wherein the second message comprises a second identity, the second identity being used to indicate a first MBS session, the first node being joined in the first MBS session; the first bearer is a DRB, and the first RNTI is an RNTI in the second candidate RNTI set.

6. The first node according to claim 1, wherein the second message indicates that data is to be transmitted via the second bearer in the RRC Inactive state.

7. The first node according to claim 1, wherein the second message indicates that data is to be transmitted via the second bearer in the RRC Connected state.

8. The first node according to claim 1, wherein the first message indicates at least one first-type DRB, and the first message does not indicate any first-type MRB; the first bearer is any first-type DRB of the at least one first-type DRB.

9. The first node according to claim 1, wherein the first message indicates at least one first-type MRB, and the first message does not indicate any first-type DRB; the first bearer is any first-type MRB of the at least one first-type MRB.

10. The first node according to claim 1, wherein the first message indicates at least one first-type DRB, and the first message indicates at least one first-type MRB; the first bearer is any first-type DRB of the at least one first-type DRB, and the second bearer is any first-type MRB of the at least one first-type MRB.

11. The first node according to claim 1, wherein the first message indicates at least one first-type DRB, and the first message indicates at least one first-type MRB; the first bearer is any first-type MRB of the at least one first-type MRB, and the second bearer is any first-type DRB of the at least one first-type DRB.

12. The first node according to claim 8, wherein the first-type DRB is a DRB that can be used for SDT; or the first-type DRB is a DRB that can be used for MT-SDT; or the first-type DRB is a DRB that can be used for MO-SDT.

13. The first node according to claim 8, wherein the first-type MRB is an MRB that can be used for receiving MBS in the RRC Inactive state.

14. The first node according to claim 1, wherein transmitting data via the first bearer in the RRC Inactive state belongs to a first RRC update procedure; the first RRC update procedure comprises: transmitting a first target message, the first target message being transmitted through a CCCH.

15. The first node according to claim 1, wherein along with the first target message, resuming the first bearer; or, the first RRC update procedure comprises: receiving a second target message; and along with the second target message, resuming the first bearer; or, as a response to receiving a first paging message, resuming the first bearer.

16. The first node according to claim 15, wherein the first paging message comprises a first identity of the first node; or, the first paging message comprises a TMGI, the first node being joined in one or more MBS sessions identified by the TMGI.

17. The first node according to claim 15, wherein during a time interval between receiving the first paging message and resuming the first bearer, the first node does not transmit an RRC message transmitted through a CCCH.

18. A second node for wireless communications, comprising:
a second transmitter, which transmits a first message, the first message indicating at least a first bearer; and transmits a first signaling and a second message, the first signaling comprising scheduling information of a first channel, and at least the second message being transmitted on the first channel, the second message being used to trigger data transmission via a second bearer;
wherein as a response to the first message being received, a receiver receiving the first message enters or stays in an RRC Inactive state; the first signaling and the second message are received by the receiver receiving the first message while transmitting data via the first bearer in the RRC Inactive state; one of the first bearer and the second bearer is an MRB while the other is a DRB; the first signaling is scrambled by a first RNTI; the first RNTI is related to the first bearer; if the first bearer is an MRB, the first RNTI is an RNTI in a first candidate RNTI set, or if the first bearer is a DRB, the first RNTI is an RNTI in a second candidate RNTI set; the first candidate RNTI set comprises at least a G-RNTI, and the second candidate RNTI set comprises at least a C-RNTI.

19. The second node according to claim 18, comprising:
a second receiver, which receives a third message, the third message being used for an RRC connection resume procedure; and
the second transmitter, which determines whether to transmit a fourth message, as a response to the third message being received;
wherein along with the RRC connection resume procedure, the second bearer is resumed; the fourth message belongs to the RRC connection resume procedure; and the second message is used to trigger the third message.

20. A method in a first node for wireless communications, comprising:
receiving a first message, the first message indicating at least a first bearer; and as a response to receiving the first message, entering or staying in an RRC Inactive state; and
receiving a first signaling and a second message while transmitting data via the first bearer in the RRC Inactive state, the first signaling comprising scheduling information of a first channel, and at least the second message being transmitted on the first channel, the second message being used to trigger data transmission via a second bearer;
wherein one of the first bearer and the second bearer is an MRB while the other is a DRB; the first signaling is scrambled by a first RNTI; the first RNTI is related to the first bearer; if the first bearer is an MRB, the first RNTI is an RNTI in a first candidate RNTI set, or if the first bearer is a DRB, the first RNTI is an RNTI in a second candidate RNTI set; the first candidate RNTI set comprises at least a G-RNTI, and the second candidate RNTI set comprises at least a C-RNTI.
